(19) United States
(12) Patent Application Publication
(10) Pub. No.: US 2026/0037344 A1
(43) Pub. Date: Feb. 5, 2026

(54) MULTI-CORE ECU INCLUDING STANDARDIZED PLATFORM AND CONTROL METHOD THEREOF

(71) Applicant: HYUNDAI AUTOEVER CORP., Seoul (KR)

(72) Inventors: Joong Seok OH, Seoul (KR); In Jung WON, Seoul (KR)

(21) Appl. No.: 19/283,790

(22) Filed: Jul. 29, 2025

(30) Foreign Application Priority Data
Aug. 2, 2024 (KR) 10-2024-0103194

(51) Int. Cl. G06F 9/54

(52) U.S. Cl. CPC G06F 9/544; G06F 9/545; G06F 9/546

(57) ABSTRACT

A multi-core ECU, which is an ECU with codes structured into a plurality of layers distributed and executed across a plurality of cores, is described. In one embodiment, the plurality of layers includes a platform layer to provide hardware-independent services through abstraction of ECU hardware, a runtime environment layer to provide a standardized interface for allowing access to the services provided by the platform layer, an application layer including a first application to be executed on a first core and a second application to be executed on a second core, the first application and the second application to use a non-standard interface which is different from the standardized interface, and an adapter layer to be executed on the first core, the adapter layer to support interface conversion of the first application and the second application.

### CROSS REFERENCE TO RELATED APPLICATION

This application claims the benefit of and priority to Korea Patent Application No. 10-2024-0103194, filed on Aug. 2, 2024, the entire contents of which are hereby incorporated herein by reference.

### FIELD OF TECHNOLOGY

The present disclosure relates to a technology of controlling an Electronic Control Unit (ECU) including multiple cores.

### BACKGROUND

An ECU may include multiple cores to provide enhanced performance. Each core may have a processor with computational capability, and the ECU allows such processors to run in parallel, thereby achieving faster task processing speed.

A multi-core ECU can perform more computational tasks simultaneously than a single-core ECU, because it is capable of parallel processing through multiple cores. This can be an advantage in handling a complex control algorithm or sensor data from multiple sources.

In a multi-core ECU, specific tasks can be distributed across multiple cores. For example, one core may handle engine control, another core may handle a safety system, and yet another core may handle infotainment. By doing so, the multi-core ECU can enhance overall system efficiency. A multi-core ECU can contribute to better system reliability and stability because, when one core experiences a problem, other cores can continue operating. This offers benefits in safety-critical systems such as those found in automobiles.

Recently, AUTOSAR (Automotive Open System Architecture) platforms are increasingly being adopted alongside multi-core ECUs.

AUTOSAR is a global development partnership founded to provide a standardized software architecture for automotive ECUs. Major automotive manufacturers, suppliers, and other companies from the software, electronics, and semiconductor industries are involved in this partnership.

AUTOSAR defines standardized interfaces and software modules to ensure compatibility across various automotive systems and components. Also, AUTOSAR provides a scalable architecture that allows for adaptation to various vehicle types, from compact cars to heavy commercial vehicles.

AUTOSAR promotes the reuse of software and hardware components, allowing developers to reduce development costs and time. Moreover, AUTOSAR enables hardware-independent software development, enhancing flexibility in system integration. Additionally, AUTOSAR provides a robust architecture to enhance vehicle safety and security.

Incidentally, AUTOSAR requires that applications are developed in compliance with standardized AUTOSAR component models. Thus, integrating existing mass-produced and validated legacy applications into AUTOSAR can be challenging. The development of applications for high-performance controllers requires a large amount of work, making it difficult to develop such legacy applications under tight time schedules using component models mandated by AUTOSAR. The development of legacy applications within a short time frame does not allow for enough time to validate an application when it is converted to an AUTOSAR component model.

### SUMMARY

Against this background, in one aspect, the present disclosure is directed to providing a technology of controlling a multi-core ECU including a standardized platform. In another aspect, the present disclosure is directed to providing a technology of integrating a legacy application into a multi-core ECU including a standardized platform. In yet another aspect, the present disclosure is directed to providing a technology of running a legacy application on a multi-core ECU using an AUTOSAR platform.

In view of the foregoing aspects, one embodiment of the present disclosure provides a multi-core ECU, which is an ECU (Electronic Control Unit) with codes structured into a plurality of layers, the codes being distributed and executed across a plurality of cores, wherein the plurality of layers includes: a platform layer which provides hardware-independent services through abstraction of ECU hardware; a runtime environment layer which provides a standardized interface for allowing access to the services provided by the platform layer; an application layer including a first application to be executed on a first core and a second application to be executed on a second core, the first application and the second application using a non-standard interface which is different from the standardized interface; and an adapter layer to be executed on the first core, which supports interface conversion of the first application and the second application.

The platform layer and the runtime environment layer may be executed on the first core.

The platform layer may provide a service for sending and receiving communication messages.

The adapter layer may include a write buffer to which an incoming message is passed from the platform layer, and a read buffer which copies the message from the write buffer, wherein the first application and the second application may read the message stored in the read buffer.

The platform layer may include a reception buffer for storing an incoming message, wherein the first application and the second application may include an application buffer for storing the message read from the read buffer.

As for a subsequent message passed to the write buffer, the adapter layer may copy the subsequent message into the read buffer, after the first application and the second application have read a current message stored in the read buffer once or more.

The first application and the second application may read the message from the read buffer by invoking a read API (Application Programming Interface) included in the adapter layer, wherein, as the read API is invoked, whether or not the first application and the second application may have read from the read buffer is checked.

The number of the plurality of cores may be N (N is a natural number equal to or greater than 2), and the adapter layer may manage whether or not each core has read from the read buffer by using N state variables.

The application layer may include at least one software component that uses a standardized interface, and the at least one software component accesses the services provided by the platform layer through the runtime environment layer.

The communication messages may be CAN (Controller Area Network) communication messages.

Another embodiment provides a control method for an ECU (Electronic Control Unit), in which codes are distributed and executed across a plurality of cores, the control method including the steps in which: a first application and a second application that use a non-standard interface are executed on a first core and a second core, respectively; an adapter layer supporting interface conversion of the first application and the second application is executed on the first core, and the adapter layer stores a new incoming message in a write buffer; the first application or the second application reads a current message stored in the read buffer; and when both the first application and the second application have read the current message stored in the read buffer, the adapter layer copies the new message stored in the write buffer into the read buffer.

The control method may further include the step in which a platform layer supporting communication hardware receives the new message and stores the same in a reception buffer, wherein the adapter layer may check for the new message in the reception buffer.

The adapter layer may check for the new message in the reception buffer by using a runtime environment layer which provides a standardized interface for allowing access to the services provided by the platform layer.

The control method may further include the step in which the platform layer and the runtime environment layer are executed on the first core, prior to the step in which the platform layer receives the new message and stores the same in the reception buffer.

In the step in which the first application or the second application reads the current message from the read buffer, when each application has read the current message, the value of a state variable assigned to each application or each core may be changed to Read.

The control method may further include the step in which the adapter layer initializes the value of the state variable assigned to each application or each core, after the step in which the new message stored in the write buffer is copied into the read buffer.

The control method may further include the step in which the first core or the second core executes at least one software component that uses the standardized interface.

The at least one component may read the new message from the reception buffer.

As explained above, according to the present disclosure, it is possible to control a multi-core ECU including a standardized platform. Moreover, according to the present disclosure, it is possible to integrate a legacy application into a multi-core ECU including a standardized platform. Additionally, according to the present disclosure, it is possible to run a legacy application on a multi-core ECU using an AUTOSAR platform.

### BRIEF DESCRIPTION OF THE DRAWINGS

FIG. 1 is a configuration diagram of an example of an ECU using a standardized platform.

FIG. 2 is a configuration diagram of a first example of an ECU according to an embodiment.

FIG. 3 is a view illustrating how the ECU according to the first example in FIG. 2 communicates with other ECUs.

FIG. 4 is a configuration diagram of a second example of an ECU according to an embodiment.

FIG. 5 is a configuration diagram of a third example of an ECU according to an embodiment.

FIG. 6 is a first view illustrating how the ECU according to the third example in FIG. 5 sends and receives messages.

FIG. 7 is a second view illustrating how the ECU according to the third example in FIG. 5 sends and receives messages.

FIG. 8 is a third view illustrating how the ECU according to the third example in FIG. 5 sends and receives messages.

FIG. 9 is a structure diagram of a memory the adapter layer uses for message management.

FIG. 10 is a flowchart of a control method for a multi-core ECU according to an embodiment.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

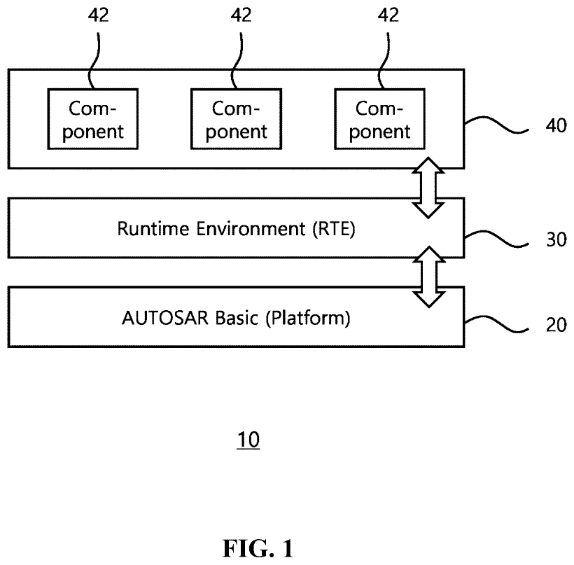

FIG. 1 is a configuration diagram of an example of an ECU using a standardized platform.

Referring to FIG. 1, the ECU 10 may include a plurality of layers. For example, the ECU 10 may include a platform layer 20, a runtime environment layer 30, and an application layer 40.

The ECU 10 may include a processor that performs a computation process, a memory that stores data, a peripheral circuit for sending and receiving electrical signals, and so on, and the aforementioned plurality of layers may be executed by such hardware—for example, a processor, a memory, and a peripheral circuit.

The hardware of the ECU 10 may execute codes. The codes may be structured into a plurality of layers as described above. For example, codes in a first group may constitute the platform layer 20, codes in a second group may constitute the runtime environment layer 30, and codes in a third group may constitute the application layer 40.

Hereinafter, a description of the hardware of the ECU 10 will be omitted for explanatory convenience, and a description will be made with respect to the layers that are executed on the ECU 10. If a layer is running, this may mean that the codes constituting that layer is loaded into hardware and the hardware then operates in accordance with instructions in the codes.

The platform layer 20 may provide hardware-independent services through abstraction of ECU hardware. For example, the platform layer 20 may be an AUTOSAR basic service layer called AUTOSAR Basic Software (BSW).

The AUTOSAR Basic Software (BSW) may include three sub-layers: a microcontroller abstraction layer; an ECU abstraction layer; and a services layer.

The microcontroller abstraction layer is a layer that directly interacts with a microcontroller, and may provide a hardware-independent interface. The ECU abstraction layer is an abstraction layer for various ECU hardware devices, and allows upper-level software to not rely on the specifics of the hardware. The services layer provides a variety of basic services, such as memory management, diagnostics, and communication services.

The runtime environment layer 30 may provide a standardized interface for allowing access to the services provided by the platform layer 20. In AUTOSAR, for example, the runtime environment layer 30 may be called RTE (Runtime Environment).

RTE may be a middleware layer that provides an interface between the application layer and the platform layer. RTE may manage data exchange between the application layer and the platform layer. Moreover, RTE may provide abstraction so that upper-level software does not need to know about the specifics of the hardware and platform layer.

The application layer 40 may include at least one software component 42 that is developed in accordance with an AUTOSAR component model. The software component 42 is a piece of software that performs a vehicle function, which may include an algorithm for controlling the vehicle's primary function, such as engine control, a braking system, and vehicle body control, may perform a driver assistance feature such as autonomous driving, lane keeping assist, and automatic emergency braking, and or may perform navigation, audio/video playback, connectivity features, and so forth.

The software component 42 may be developed in accordance with an AUTOSAR component model, and accordingly the software component 42 is able to access the platform layer 20 using an RTE interface.

Incidentally, it is hard to integrate a previously developed and validated application into such an ECU system structure. To address this, one embodiment proposes a new structure that allows for the incorporation of a previously validated legacy application into an ECU including a standardized platform such as AUTOSAR.

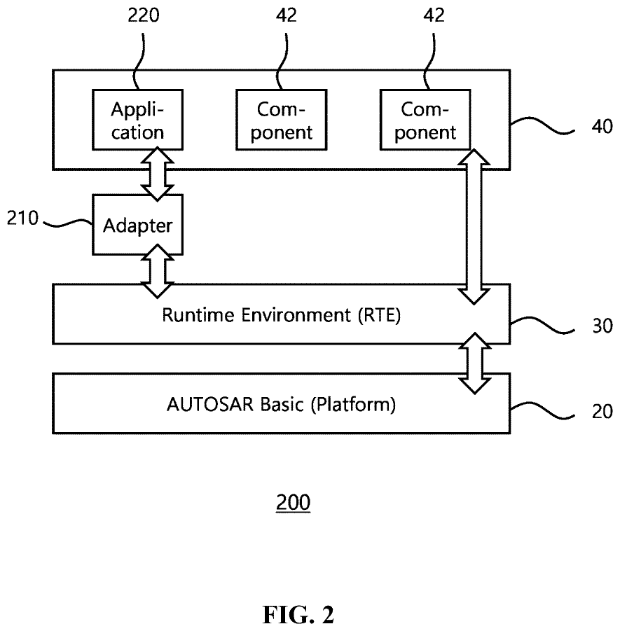

FIG. 2 is a configuration diagram of a first example of an ECU according to an embodiment.

Referring to FIG. 2, the ECU 200 may include a platform layer 20, a runtime environment layer 30, an application layer 40, and an adapter layer 210.

The platform layer 20 may provide hardware-independent services through abstraction of ECU hardware. For example, the platform layer 20 may provide a service for sending and receiving communication messages. The communication messages may be CAN (Controller Area Network) communication messages.

The runtime environment layer 30 may provide a standardized interface for allowing access to the services provided by the platform layer 20.

The application layer 40 may include at least one software component 42 that uses a standardized interface provided by the runtime environment layer 30. The software component 42 may access the services provided by the platform layer 20 through the runtime environment layer 30.

The application layer 40 may include an application 220 that uses a non-standard interface which is different from the standardized interface. The application 220 may include codes that are developed in different environments and codes whose performance is validated in different environments.

The application 220 may not use a standardized interface provided by the runtime environment layer 30. Accordingly, the application 220 may not be able to directly invoke the runtime environment layer 30.

The adapter layer 210 may support interface conversion so that the application 220 uses the runtime environment layer 30. The adapter layer 210 allows a non-standard interface used by the application 220 to work together with an API (Application Programming Interface). Also, the adapter layer 210 may access the runtime environment layer 30 by using a standardized interface. With this structure, the adapter layer 120 may receive a request from the application 220 using the non-standard interface and pass the request to the runtime environment layer 30 to adapt to the standardized interface.

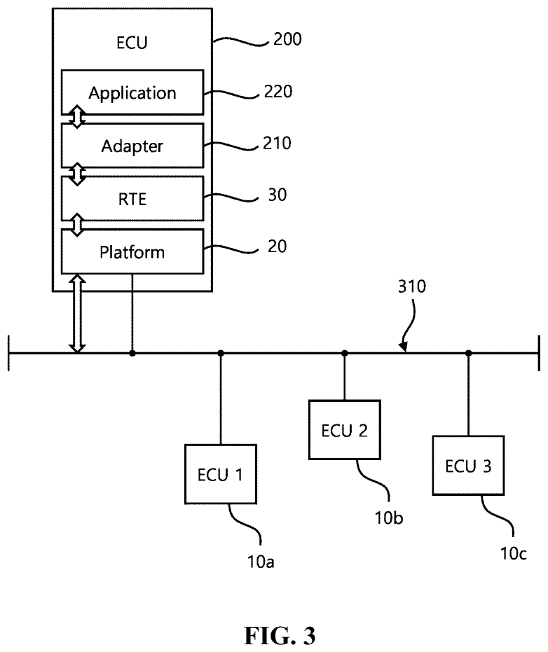

FIG. 3 is a view illustrating how the ECU according to the first example in FIG. 2 communicates with other ECUs.

Referring to FIG. 3, the ECU 200 may be connected to other ECUs 10a, 10b, and 10c via a communication line 310. The communication line 310 as used herein may be a CAN bus.

CAN (Controller Area Network) communication is a standard protocol for communication between multiple ECUs within a vehicle. CAN communication may reduce the complexity of vehicle networks and enhance data transmission reliability and speed.

CAN communication is a serial communication protocol designed for distributed control systems. It enables multiple ECUs to share the same CAN bus and exchange data via the CAN bus. The CAN bus may transmit data using two wires.

A CAN communication message may include an identifier, a control field, a data field, a CRC (Cyclic Redundancy Check) field, an ACK (Acknowledge) field, and an end field. The identifier may represent the priority and destination of the message. The control field may represent the length of the data field. The data field may contain data to be transmitted. The CRC field may be used for error detection in the message, and the ACK field may be used to indicate a successful message transmission by the receiver. The end field may represent the end of the message.

CAN communication is a message-oriented protocol, and each message may have a specific identifier. All nodes on a CAN bus can receive messages, but each node handles only those messages that are relevant to them.

The ECU 200 according to an embodiment may receive a communication message from other ECUs 10a, 10b, and 10c through the platform layer 20. The communication message may be received by the platform layer 20 and then passed to the adapter layer 210 through the runtime environment layer 30. The application 220 may read the communication message through the adapter layer 210.

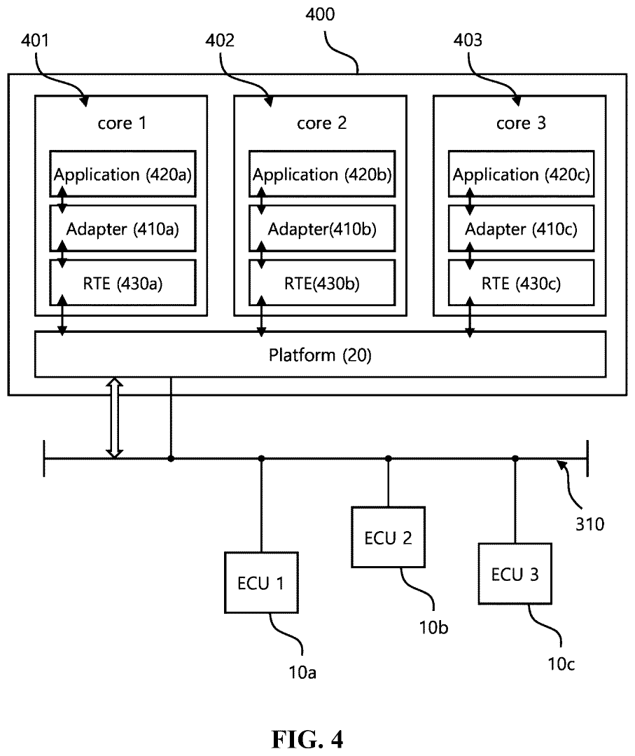

FIG. 4 is a configuration diagram of a second example of an ECU according to an embodiment.

Referring to FIG. 4, the ECU 400 may be a multi-core ECU including a plurality of cores 401, 402, and 403.

The ECU 400 may include a platform layer 20, runtime environment layers 430a, 430b, and 430c, adapter layers 410a, 410b, and 410c, and application layers 420a, 420b, and 420c. The layers may be configured to be distributed across the cores.

The first application 420a, the first adapter 410a, and the first RTE 430a may be executed on the first core 401. The second application 420b, the second adapter 410b, and the second RTE 430b may be executed on the second core 402. The third application 420c, the third adapter 410c, and the third RTE 430c may be executed on the third core 403.

Upon receiving a new message from other ECUs 10a, 10b, and 10c, the platform layer 20 may store the new message in a reception buffer placed in a memory or the like.

The first adapter 410a executed on the first core 401 may receive the new message from the reception buffer through the first RTE 430a. The first application 420a may read the new message stored in the first adapter 410a via a non-standard interface.

The second adapter 410b executed on the second core 402 may receive the new message from the reception buffer through the second RTE 430b. The second application 420b may read the new message stored in the second adapter 410b via a non-standard interface.

The third adapter 410c executed on the third core 403 may receive the new message from the reception buffer through the third RTE 430c. The third application 420c may read the new message stored in the third adapter 410c via a non-standard interface.

With each core having its own adapter, the integrity of a message can be guaranteed when the message is sent and received. However, with this structure, each core individually invokes the RTE to send and receive messages, which leads to an increase in computation load. For operation with limited resources, it is necessary to efficiently manage computation load, which is not possible with this structure. As a result, other tasks related to safety may be delayed, which may lead to highly disruptive consequences. Moreover, the incorporation of adapters performing redundant functions into the cores may result in inefficient memory management.

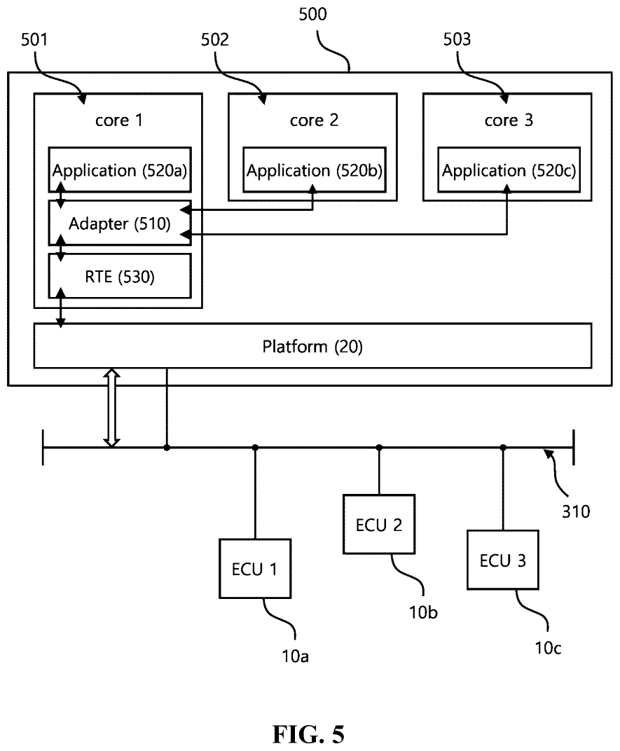

FIG. 5 is a configuration diagram of a third example of an ECU according to an embodiment.

Referring to FIG. 5, the ECU 500 may be a multi-core ECU including a plurality of cores 501, 502, and 503.

The ECU 500 may include a platform layer 20, a runtime environment layer 530, an adapter layer 510a, and application layers 520a, 520b, and 520c. The layers may be configured to be distributed across the cores.

The platform layer 20 may provide hardware-independent services through abstraction of ECU hardware. For example, the platform layer 20 may provide a service for sending and receiving communication messages. The communication messages may be CAN (Controller Area Network) communication messages.

The runtime environment layer 530 may provide a standardized interface for allowing access to the services provided by the platform layer 20.

The applications 520a, 520b, and 520c of the application layer may be distributed and executed across the cores. For example, the first application 520a may be executed on the first core 501. The second application 520b may be executed on the second core 502. The third application 520c may be executed on the third core 503. Although not shown, the application layer may include at least one software component that uses a standardized interface. The software component may access the services provided by the platform layer 20 through the runtime environment layer 530.

The application layers 520a, 520b, and 520c may use a non-standard interface which is different from the standardized interface provided by the runtime environment layer 530.

Accordingly, the applications 520a, 520b, and 520c may access the runtime environment layer 530 and/or the platform layer 20 through the adapter layer 510, thereby allowing for the use of the services provided by the platform layer 20.

The adapter layer 510 may support interface conversion of the applications 520a, 520b, and 520c.

The adapter layer 510 may be executed on the first core 501. The runtime environment layer 530 also may be executed on the first core 501. The platform layer 20 also may be executed on the first core 501.

The platform layer 20 may provide a service for sending and receiving communication messages. The applications 520a, 520b, and 520c may exchange messages with other ECUs 10a, 10b, and 10c which are external, through the platform layer 20.

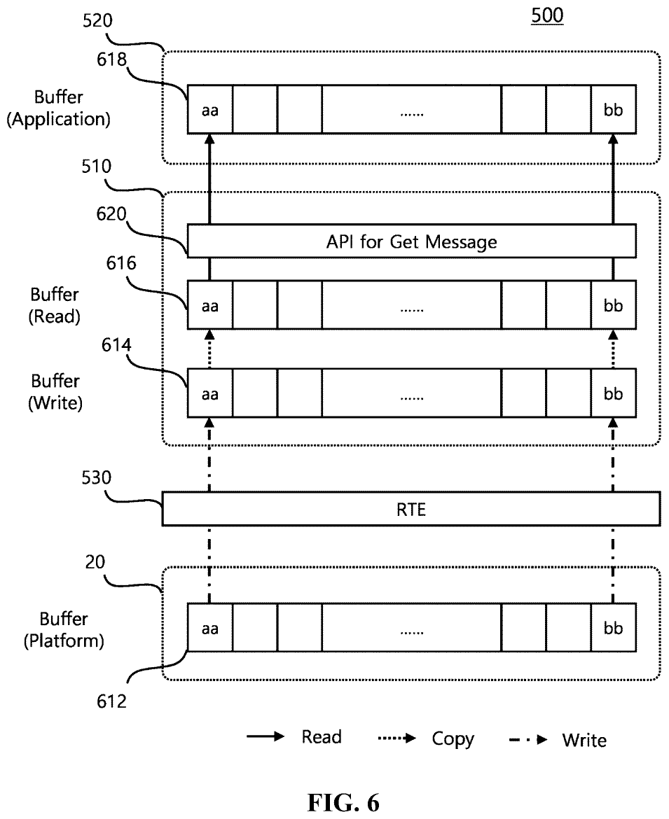

FIG. 6 is a first view illustrating how the ECU according to the third example in FIG. 5 sends and receives messages.

Referring to FIG. 6, the platform layer 20, the adapter layer 510, and the application 520 may include buffers for storing messages temporarily or on a long-term basis.

The platform layer 20 may include a reception buffer 612 for storing an incoming message.

The adapter layer 510 may include a write buffer 614 to which an incoming message is passed from the platform layer 20, and a read buffer 616 which copies the message from the write buffer 614. The adapter layer 510 may receive a message from the reception buffer 612 of the platform layer 20 through the runtime environment layer 530 and store it in the write buffer 614. The adapter layer 510 then may copy the message stored in the write buffer 614 into the read buffer 616 according to a predefined rule.

The adapter layer 510 may include a read API (Application Programming Interface) 620. The read API 620 may be invoked by the application 520, and once the read API 620 is invoked, the message stored in the read buffer 616 may be passed to the application 520.

The application 520 may include an application buffer 618. Also, the application 520 may store, in the application buffer 618, the message read by invoking the read API 620 of the adapter layer 510

When a task message is received by the reception buffer 612, the task message is passed to the write buffer 614 of the adapter layer 510. The task message is then copied from the write buffer 614 into the read buffer 616 and copied again from the read buffer 616 into the application buffer 618.

Such a buffer structure may have a more advantageous effect in in a multi-core environment.

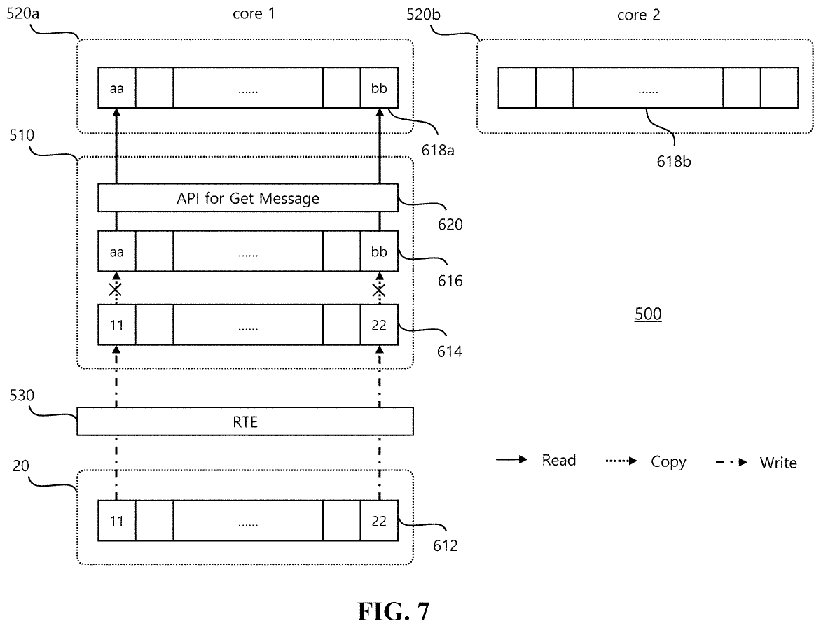

FIG. 7 is a second view illustrating how the ECU according to the third example in FIG. 5 sends and receives messages.

Referring to FIG. 7, a task message aa . . . bb is stored in the read buffer 616 of the adapter layer 510. The first application 520a executed on the first core has read the task message aa . . . bb stored in the read buffer 616 by invoking the read API 620 and has stored it in a first application buffer 618a. The second application 520b executed on the second core has not read from the read buffer 616 yet, and a second application buffer 618b may be empty.

In this state, the platform layer 20 may receive another task message 11 . . . 22 and store it in the reception buffer 612. The adapter layer 510 may read the task message 11 . . . 22 stored in the reception buffer 612 through the runtime environment layer 530 and store it in the write buffer 614. At this point, however, the adapter layer 510 may not copy the task message 11 . . . 22 stored in the write buffer 614 into the read buffer 616. On the other hand, if the adapter layer 510 copies the task message 11 . . . 22 stored in the write buffer 614 into the read buffer 616, the second application 520b executed on the second core may not be able to receive the task message aa bb.

Suppose that the task message stored in the read buffer 616 is a current message and the another task message passed to the read buffer 614 through the reception buffer 612 is a subsequent message. As for a subsequent message passed to the write buffer 614, the adapter layer 510 may copy the subsequent message into the read buffer 616 after the first application 520a and the second application 520b have read the current message stored in the read buffer 616 once or more.

The first application 520a and the second application 520b read the message from the read buffer 616 by invoking the read API 620 included in the adapter layer 510. As the read API 520 is invoked, the adapter layer 510 may check whether or not the first application 520a and the second application 520b have read from the read buffer 616.

When invoking the read API 620, the first application 520a and the second application 520b may provide an applications-specific unique identification number as an argument or provide a core-specific unique identification number as an argument. The adapter layer 510 may check which application or which core has read the current message by checking the unique identification number.

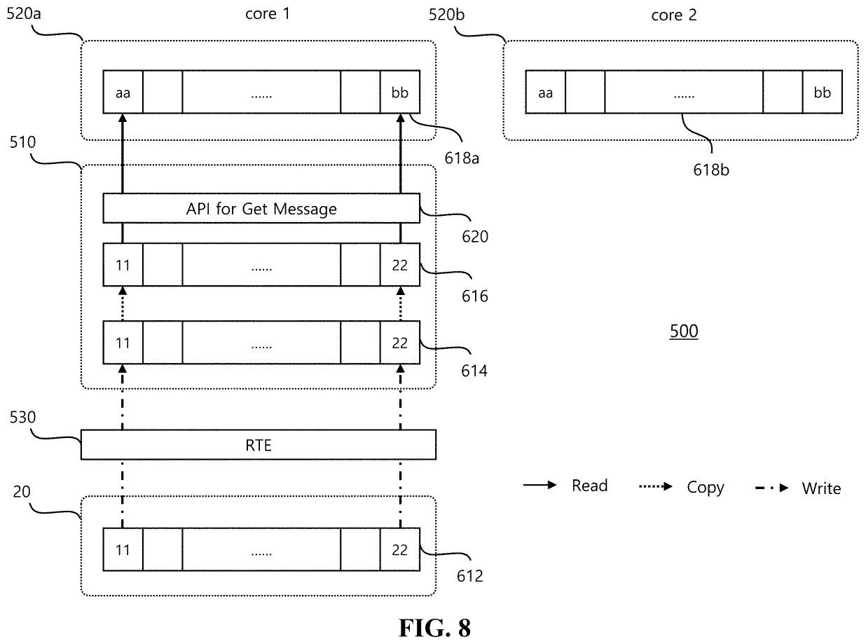

FIG. 8 is a third view illustrating how the ECU according to the third example in FIG. 5 sends and receives messages.

Referring to FIG. 8, a comparison with what is shown in FIG. 7 demonstrates that the second application 520b executed on the second core has read the task message aa . . . bb stored in the read buffer 616 by invoking the read API 620 and has stored in the second application buffer 618b.

In this state, the adapter layer 510 may copy the task message 11 . . . 22 stored in the write buffer 614 into the read buffer 616.

Also, the adapter layer 510 may initialize the read status for each application or each core in relation to the read buffer 616

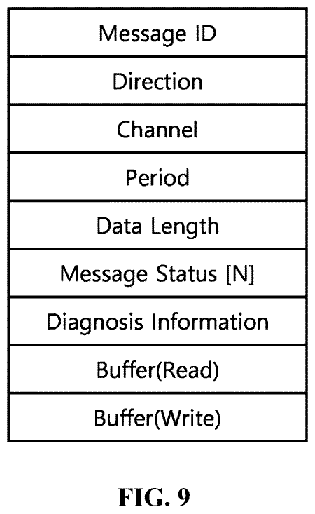

FIG. 9 is a structure diagram of a memory the adapter layer uses for message management.

Referring to FIG. 9, the adapter layer may manage a data structure including multiple fields in memory.

The data structure may include message identifier, direction, channel, period, data length, message status, diagnosis information, read buffer, write buffer, and so forth.

The message identifier may contain information on the priority of the message, the destination of the message, and so forth. The direction field may indicate whether the message is an outgoing message or an incoming message. In multi-channel CAN communication, the channel identifier may be managed in the channel field. The period field may store a transmission interval value. The data length field may store the length of the message stored in the write buffer or the read buffer. The message status field may manage the read status of the message.

If an ECU includes N cores (N is a natural number equal to or greater than 2), the message status field may contain N state variables. The adapter layer may manage whether or not each core has read from the read buffer by using the N state variables.

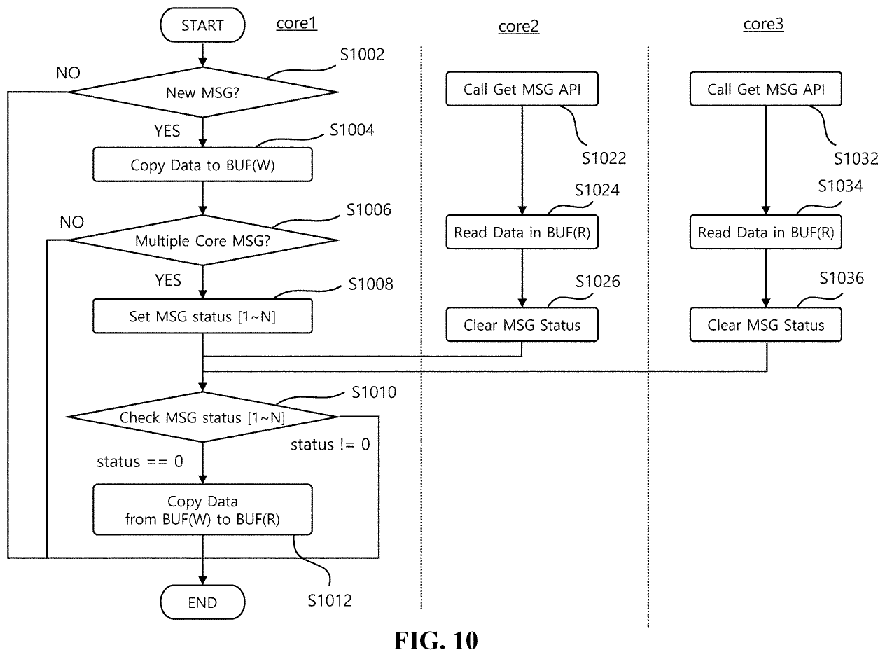

FIG. 10 is a flowchart of a control method for a multi-core ECU according to an embodiment.

A first application, a second application, and a third application, which use a non-standard interface, may be executed on a first core, a second core, and a third core, respectively.

Referring to FIG. 10, the adapter layer executed on the first core checks for a new incoming message (S1002), and, if there is a new message (YES in S1002), may store the new message in the write buffer (S1004).

The adapter layer may check whether the new message is destined for multiple cores. If the new message is supposed to be sent to a plurality of cores (YES in S1006), the adapter layer may check the read status in relation to the read buffer (S1010).

There may be N state variables representing the read status for each core, and the initial value of each state variable may be set to 1. When each core reads the read buffer, the state variable may be changed to 0. If every state variable has a value of 0, the adapter layer may copy the new message stored in the write buffer into the read buffer (S1012). If a certain state variable has a value other than 0, the adapter layer may not copy the new message into the read buffer.

The first application executed on the first core may read the current message stored in the read buffer so that the state variable corresponding to the first application is cleared to 0.

The second application executed on the second core may invoke the read API of the adapter layer (S1022). The second application may read the current message stored in the read buffer (S1024). The second application may clear the state variable corresponding to the second application to 0 (S1026).

The third application executed on the third core may invoke the read API of the adapter layer (S1032). The third application may read the current message stored in the read buffer (S1034). The third application may clear the state variable corresponding to the third application to 0 (S1036).

Such a control method may further include the step in which, before the adapter checks for a new incoming message, the platform layer controlling communication hardware receives the new message and stores the same in the reception buffer. The adapter layer may check for a new message in the reception buffer. Prior to this step, the platform layer and the runtime environment layer may be executed on the first core.

The adapter layer may check for a new message in the reception buffer by using the runtime environment layer which provides a standardized interface for allowing access to the services provided by the platform layer.

When the first application or the second application or the third application has read the current message from the read buffer, the value of a state variable assigned to each application or each core may be changed to Read.

The control method may further include the step in which the adapter layer initializes the value of the state variable assigned to each application or each core, after the step 1012 of copying the new message stored in the write buffer into the read buffer. This step may be placed at S1008 in FIG. 10 or at any other position.

The control method may further include the step in which the first core or the second core executes at least one software component that uses a standardized interface. The at least one software component may read a new message from the reception buffer.

As explained above, according to the present disclosure, it is possible to control a multi-core ECU including a standardized platform. Moreover, according to the present disclosure, it is possible to integrate a legacy application into a multi-core ECU including a standardized platform. Additionally, according to the present disclosure, it is possible to run a legacy application on a multi-core ECU using an AUTOSAR platform.

The terms “include,” “comprise,” or “have” as used herein, unless otherwise specifically stated, imply that the corresponding component may be included, and therefore should be interpreted as including other components rather than excluding other components. All terms, including technical or scientific terms, unless otherwise defined, have the same meaning as commonly understood by a person of ordinary skill in the art to which this disclosure pertains. Commonly used terms, such as terms defined in a dictionary, should be interpreted as being consistent with their contextual meaning in the relevant art, and shall not be interpreted in an idealistic or overly formal sense, unless expressly defined in the present disclosure.

The above description is merely an illustrative description of the technical idea of the present disclosure, and those skilled in the art will appreciate that various modifications and variations may be made without departing from the essential characteristics of the present disclosure. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the rights of the present disclosure.

What is claimed is:

1. A multi-core electronic control unit (ECU), which is an ECU with codes structured into a plurality of layers and distributed and executed across a plurality of cores,
wherein the plurality of layers comprises:
a platform layer to provide hardware-independent services through abstraction of ECU hardware;
a runtime environment layer to provide a standardized interface for allowing access to the services provided by the platform layer;
an application layer including a first application to be executed on a first core and a second application to be executed on a second core, the first application and the second application to use a non-standard interface which is different from the standardized interface; and
an adapter layer to be executed on the first core, the adapter layer to support interface conversion of the first application and the second application.

2. The multi-core ECU of claim 1, wherein the platform layer and the runtime environment layer are executed on the first core.

3. The multi-core ECU of claim 1, wherein the platform layer provides a service for sending and receiving communication messages.

4. The multi-core ECU of claim 3, wherein the adapter layer includes a write buffer to which an incoming message is passed from the platform layer and a read buffer which copies the incoming message from the write buffer, and wherein the first application and the second application read the incoming message stored in the read buffer.

5. The multi-core ECU of claim 4, wherein the platform layer includes a reception buffer for storing the incoming message, and wherein the first application and the second application include an application buffer for storing the incoming message read from the read buffer.

6. The multi-core ECU of claim 4, wherein, as for a subsequent message passed to the write buffer, the adapter layer copies the subsequent message into the read buffer after a current message stored in the read buffer is read by the first application and the second application at least once.

7. The multi-core ECU of claim 6, wherein the first application and the second application read the current message from the read buffer by invoking a read application programming interface (API) included in the adapter layer, and wherein, as the read API is invoked, whether or not the first application and the second application are read from the read buffer is checked.

8. The multi-core ECU of claim 7, wherein a number of the plurality of cores is a natural number (N) equal to or greater than 2, and the adapter layer manages whether or not each of the plurality of cores is read from the read buffer by using N state variables.

9. The multi-core ECU of claim 1, wherein the application layer includes at least one software component that uses the standardized interface, and the at least one software component accesses the services provided by the platform layer through the runtime environment layer.

10. The multi-core ECU of claim 3, wherein the communication messages are Controller Area Network (CAN) communication messages.

11. A control method for an ECU with codes structured into a plurality of layers and distributed and executed across a plurality of cores of the ECU, the control method comprising:
executing on a first core and a second core of the ECU a first application and a second application that use a non-standard interface, respectively;
executing on the first core an adapter layer supporting interface conversion of the first application and the second application, wherein the adapter layer includes a write buffer to store a new incoming message;
reading, using the first application or the second application, a current message stored in a read buffer; and
copying the current message stored in the write buffer into the read buffer when both the first application and the second application have read the current message stored in the read buffer.

12. The control method of claim 11, further comprising receiving, using a platform layer supporting communication hardware, a new message and storing the new message in a reception buffer, wherein the adapter layer checks for the new message in the reception buffer.

13. The control method of claim 12, wherein the adapter layer checks for the new message in the reception buffer by using a runtime environment layer which provides a standardized interface for allowing access to services provided by the platform layer.

14. The control method of claim 13, further comprising executing on the first core the platform layer and the runtime environment layer prior to receiving, at the platform layer, the new message and storing the new message in the reception buffer.

15. The control method of claim 11, wherein, during the step of reading, using the first application or the second application, the current message stored in the read buffer, when each application has read the current message, a value of a state variable assigned to the each application or each core is changed to Read.

16. The control method of claim 15, further comprising initializing, using the adapter layer, the value of the state variable assigned to the each application or the each core once the step of copying the current message stored in the write buffer into the read buffer is performed.

17. The control method of claim 13, further comprising executing, using the first core or the second core, at least one software component that uses the standardized interface.

18. The control method of claim 17, wherein the at least one software component reads the new message from the reception buffer.
